(19) United States
(12) Patent Application Publication
(10) Pub. No.: US 2014/0342680 A1
(43) Pub. Date: Nov. 20, 2014

(54) SIGNAL AMPLIFYING APPARATUS, TRANSMITTER, AND SIGNAL AMPLIFYING METHOD

(71) Applicant: FUJITSU LIMITED, Kawasaki-shi (JP)

(72) Inventor: Shin WATANABE, Yokohama (JP)

(73) Assignee: FUJITSU LIMITED, Kawasaki-shi (JP)

(21) Appl. No.: 14/248,459

(22) Filed: Apr. 9, 2014

(30) Foreign Application Priority Data
May 17, 2013 (JP) 2013-105575

(51) Int. Cl. H04B 1/62; H04B 1/04

(52) U.S. Cl. CPC H04B 1/62; H04B 1/0475; H04B 2001/0425
USPC 455/114.3

(57) ABSTRACT

A transmission signal amplifying apparatus has an OFDM subcarrier division unit, a transmission side analog unit, a digital distortion compensation unit, and a main signal combiner. The OFDM subcarrier division unit divides a signal whose frequency bands are continuous, and outputs a plurality of subcarrier aggregations obtained by the division in a state in which the frequency bands are adjacent to each other. The transmission side analog unit amplifies signals of a plurality of systems having the respective output subcarrier aggregations for the respective signals of the respective systems, while maintaining the above-described state. The digital distortion compensation unit compensates distortions of the amplified signals of the plurality of systems. The main signal combiner combines the signals of the plurality of systems whose distortions have been compensated, and outputs as an RF signal.

### CROSS-REFERENCE TO RELATED APPLICATION

This application is based upon and claims the benefit of priority of the prior Japanese Patent Application No. 2013-105575, filed on May 17, 2013, the entire contents of which are incorporated herein by reference.

### FIELD

The embodiments discussed herein are related to a signal amplifying apparatus, a transmitter, and a signal amplifying method.

### BACKGROUND

In recent years, in a field of a radio mobile body communication, a technology conforming to an International Mobile Telecommunication (IMT)-Advanced, which is a fourth generation standard, has been developed to provide a faster and high quality mobile service. In the IMT-Advanced, instead of a related frequency band of 800 MHz to 2 GHz, the use of a frequency band of 3.5 GHz capable of obtaining a broadband and continuous spectrum has been considered. Following this, extension of a bandwidth used for signal transmission from a related maximum bandwidth of 20 MHz to a maximum bandwidth of 100 MHz (e.g., approximately 80 MHz) has been also considered.

In a radio apparatus, such as a base station, a mobile station, or the like, at the time of signal transmission, a power amplifier (PA) power-amplifies a baseband (BB) signal converted into a radio frequency, and then a band is limited by a band pass filter (BPF), and a radio transmission signal is output. However, since the signal power-amplified by the PA is distorted due to non-linearity of the PA, leakage power to an adjacent channel (ACLP: Adjacent Channel Leak Power) increases. Since this ACLP disturbs a peripheral channel or a receiving channel of its own apparatus, it is desirable that signal power be attenuated to a predetermined value.
Patent Document 1: Japanese Laid-open Patent Publication No. 2006-140785
Patent Document 2: Japanese Laid-open Patent Publication No. 2012-089997
Patent Document 3: Japanese Laid-open Patent Publication No. 2003-092518
Patent Document 4: Japanese Laid-open Patent Publication No. 2008-252256

However, for example, in a case where a bandwidth used for signal transmission (referred “signal bandwidth” hereinafter) and a pass band of a BPF are wide, and a desired amount of attenuation by the BPF is large, it is difficult to realize characteristics desired for the BPF. In other words, in the radio apparatus, in order to satisfy the characteristics desired for the BPF in the above-described case, a size of the BPF is increased. As a result, there are problems such that miniaturization of the apparatus becomes difficult and manufacturing costs increase.

For example, in a case where the radio apparatus handles a broadband signal with a signal bandwidth of 80 MHz, a transmission band and a reception band can be adjacent depending on allocation of bands. More specifically, in a case where 80 MHz of 3510 to 3590 MHz is allocated as the transmission band and 80 MHz of 3410 to 3490 MHz is allocated as the reception band, a frequency interval between the respective bands is only 20 MHz. Because of this, especially in a case where distortion of a transmission wave is large and an amount of attenuation of the reception band by the BPF is small, a distortion signal of the transmission wave is mixed in the reception band of its own apparatus, thereby degrading radio quality.

To solve the above-described problem, it is effective for the BPF to put a notch characteristic into predetermined frequencies (e.g., 3480 MHz, 3490 MHz) and secure an amount of attenuation of the reception band to 100 dB. However, since the number of resonators, to which the notch, is limited, the number of notches is also limited. If the notches are concentrated on the reception band side of the BPF, it is difficult for the notches to be added to a high frequency side thereof (e.g., 3600 MHz or more). As a result, the high frequency side has an attenuation characteristic which is not steep but diagonal.

Here, in a case where a channel for another system is allocated to the high frequency side (e.g., 3600 to 3700 MHz), in order to suppress interference to the system, the radio apparatus preferably suppresses spurious radiation which is arisen from ACLP generated by distortion of the PA. However, as described above, since the number of notches is limited to suppress the ACLP by the BPF, it is desirable that the radio apparatus suppress the distortion generation of the PA itself to reduce the ACLP.

The distortion generation in the PA can be suppressed by a distortion compensation circuit. However, in a case where the radio apparatus cannot sufficiently suppress the distortion even if the distortion compensation circuit is used, there is a method of increasing power consumption of the PA and improving linearity of the PA. However, even in the above-described method, there is a problem in that the linearity is improved while the power consumption of the apparatus increases.

Further, there is also a method in which the radio apparatus provides the BPF itself with a characteristic having a bandwidth of approximately 80 MHz in a high frequency band of approximately 3.5 GHz. However, a large number of resonators are used in this method, and it is difficult to realize the method from the viewpoint of mass productivity and costs.

The difficulty of suppressing the ACLP resulting from the above-described problems has been a factor that inhibits highly efficient amplification of a continuous broadband signal.

### SUMMARY

According to an aspect of the embodiments, a signal amplifying apparatus includes: a division unit that divides a signal whose frequency bands are continuous, and outputs a plurality of subcarrier aggregations obtained by the division, in a state in which the frequency bands are not adjacent to each other; an amplification unit that amplifies signals of a plurality of systems having the respective subcarrier aggregations output from the division unit for the respective signals of the systems, while maintaining the state; a distortion compensation unit that compensates distortions of the signals of the plurality of systems amplified by the amplification unit; and a combining unit that combines the signals of the plurality of systems whose distortions have been compensated by the distortion compensation unit, and outputs as a radio signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a structure of a transmission signal amplifying apparatus according to a present embodiment;

FIG. 2A is a diagram illustrating a spectrum of an output signal from a power amplifier 13b-1 during a distortion compensating operation;

FIG. 2B is a diagram illustrating a spectrum of an output signal from a power amplifier 13b-2 during a distortion compensating operation;

FIG. 3A is a diagram illustrating a pass band characteristic of a BPF 16-1;

FIG. 3B is a diagram illustrating a pass band characteristic of a BPF 16-2;

FIG. 4A is a diagram illustrating the pass band characteristic of the BPF 16-1 and an attenuated spectrum of the output signal from the power amplifier 13b-1;

FIG. 4B is a diagram illustrating the pass band characteristic of the BPF 16-2 and an attenuated spectrum of the output signal from the power amplifier 13b-2;

FIG. 5 is a diagram illustrating a combined spectrum of a BB signal S1-1 having passed through the BPF 16-1 and a BB signal S1-2 having passed through the BPF 16-2;

FIG. 6 is a diagram illustrating a structure of a base station having the transmission signal amplifying apparatus according to the present embodiment;

FIG. 7 is a diagram illustrating a structure of a portable terminal in a case where a Base band (BB) unit does not include an OFDM subcarrier division unit according to the present embodiment; and

FIG. 8 is a diagram illustrating a structure of a portable terminal in a case where a Base band (BB) unit includes the OFDM subcarrier division unit according to the present embodiment.

### DESCRIPTION OF EMBODIMENTS

Preferred embodiments will be explained with reference to accompanying drawings. The signal amplifying apparatus, the transmitter, and the signal amplifying method disclosed herein are not limited by the following embodiment.

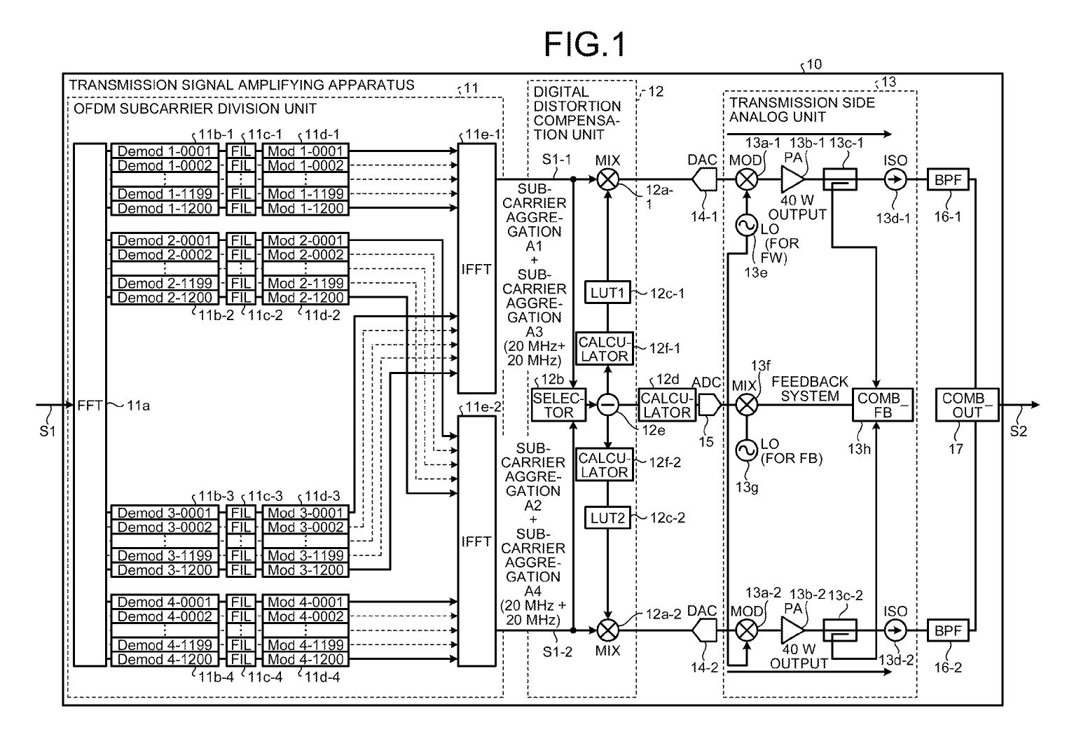

FIG. 1 is a diagram illustrating a structure of a transmission signal amplifying apparatus 10 according to a present embodiment. As illustrated in FIG. 1, the transmission signal amplifying apparatus 10 has an orthogonal frequency division multiplexing (OFDM) subcarrier division unit 11, a digital distortion compensation unit 12, and a transmission side analog unit 13. These respective components are connected so as to be capable of inputting and outputting a signal or data in one direction or two directions. The transmission signal amplifying apparatus 10 adopts a configuration in which the OFDM subcarrier division unit 11 decomposes a digital Base band (BB) signal S1 (simply referred “BB signal S1” hereinafter) into a plurality of subcarriers, and then respective power amplifiers 13b-1, 13b-2 of different systems amplify each BB signal S1.

Further, the digital distortion compensation unit 12 and the transmission side analog unit 13 configure a distortion compensation circuit of a second system by a forward system of a second system and a feedback system of a first system which combines signals branched from two directional couplers (COUPLER) 13c-1, 13c-2. However, a local oscillator 13e for forward (FW) and a local oscillator 13g for distortion compensation feedback (FB) are shared by both systems. The local oscillator 13e inputs signals to modulators (MOD) 13a-1, 13a-2, which convert radio frequencies. The local oscillators 13e, 13g, for example, oscillate a signal with a frequency of 3550 MHz.

The BB signal S1 input to the transmission signal amplifying apparatus 10 in FIG. 1 is a signal of orthogonal frequency division multiple access (OFDMA) provided by an IMT-Advanced. Accordingly, the BB signal S1 becomes a signal combining the respective subcarriers on a frequency axis. When the BB signal S1 is input to the OFDM subcarrier division unit 11, the BB signal S1 is transformed into data on a frequency axis from data on a time axis by a fast fourier transform (FFT) 11a. The transformed data is demodulated for every aggregation of the subcarriers by demodulators (Demod) 11b-1 to 11b-4. Consequently, a plurality of subcarrier signals is generated.

After unnecessary signals of the other subcarriers are eliminated by respective band limiting filters (FIL) 11c-1 to 11c-4, signals of the respective subcarriers are modulated by modulators (Mod) 11d-1 to 11d-4. The modulated signals of the respective subcarriers are input to inverse fast fourier transform (IFFTs) 11e-1, 11e-2 as subcarrier aggregations A1 to A4.

At the time of the input, the IFFT 11e-1 inputs 1200 subcarriers, which are the sum of modulation signals 1-0001 to 1-1200, as the subcarrier aggregation A1, and inputs 1200 subcarriers, which are the sum of modulation signals 3-0001 to 3-1200, as the subcarrier aggregation A3. By applying inverse fast fourier transform to the subcarrier aggregations A1, A3 whose frequency bands are not adjacent to each other, the IFFT 11e-1 outputs a BB signal S1-1 with a sum of 40 (=20+20) MHz.

On the other hand, processing which is similar to that of the IFFT 11e-1 is also performed in the IFFT 11e-2. In other words, the IFFT 11e-2 inputs 1200 subcarriers, which are the sum of modulation signals 2-0001 to 2-1200, as the subcarrier aggregation A2, and inputs 1200 subcarriers, which are the sum of modulation signals 4-0001 to 4-1200, as the subcarrier aggregation A4. By applying inverse fast fourier transform to the subcarrier aggregations A2, A4 whose frequency bands are not adjacent to each other, the IFFT 11e-2 outputs a BB signal S1-2 with a sum of 40 (=20+20) MHz.

As described above, the BB signal S1 input with a bandwidth of 80 MHz (total 4800 subcarriers) is divided into the two aggregations, and then is transformed into the time axis data from the frequency data of each subcarrier through the inverse fast fourier transform. With this configuration, the BB signals 51-1, S1-2 for two types of carriers on the time axis are generated, and each signal is individually input to the digital distortion compensation unit 12.

In the digital distortion compensation unit 12, the BB signal 51-1 output from the IFFT 11e-1 is branched into a signal input to a multiplier (MIX) 12a-1 and a signal input to a selector 12b. The multiplier (MIX) 12a-1 multiplies the input signal by a distortion compensation coefficient stored in a distortion compensation coefficient memory 12c-1 for the first system. The multiplied signal is converted into an analog signal by a digital to analog converter (DAC) 14-1, and is then input to the transmission side analog unit 13.

In the transmission side analog unit 13, the modulator (MOD) 13a-1 mixes the local oscillator 13e for ForWard and converts a frequency of the BB signal S1-1 into a transmission radio frequency. The converted BB signal S1-1 is power-amplified by the power amplifier (PA) 13b-1 for the first system, and then a part of the BB signal S1-1 is separated by the directional coupler 13c-1 for the first system. The separated BB signal S1-1 is output to the feedback system.

On the other hand, processing which is similar to that of the IFFT 11e-1 is also performed to the output signal from the IFFT 11e-2. In other words, in the digital distortion compensation unit 12, the BB signal S1-2 output from the IFFT 11e-2 is branched into a signal input to a multiplier (MIX) 12a-2 and a signal input to the selector 12b. The multiplier (MIX) 12a-2 multiplies the input signal by a distortion compensation coefficient stored in a distortion compensation coefficient memory 12c-2 for the second system. The multiplied signal is converted into an analog signal by a DAC 14-2, and is then input to the transmission side analog unit 13.

In the transmission side analog unit 13, the modulator (MOD) 13a-2 mixes the local oscillator 13e for ForWard and converts a frequency of the BB signal S1-2 into a transmission radio frequency. The converted BB signal S1-2 is power-amplified by the power amplifier (PA) 13b-2 for the second system, and then a part of the BB signal S1-2 is separated by the directional coupler (COUPLER) 13c-2 for the second system. The separated BB signal S1-2 is output to the feedback system.

A combiner for an FB path (COMB. FB) 13h combines signals input from the respective directional couplers 13c-1, 13c-2 and outputs to a multiplier (MIX) 13f. In the multiplier 13f, the local oscillator 13g for feedback converts a frequency of the input combined signal into an intermediate frequency (IF), and outputs to an analog to digital converter (ADC) 15.

A calculator 12d performs FFT processing to the signal input from the ADC 15, thereby extracting a frequency component. Specifically, in the calculator 12d, a digital filter extracts subcarrier aggregations A1, A3 and distortion signals of distortion compensation monitor points (3490 MHz, 3610 MHz) from the signal input from the ADC 15, and outputs the subcarrier aggregations A1, A3 and the distortion signals to a comparator 12e.

When distortion compensation of the first system is performed, the selector 12b sets a path in such a manner that the signal branched from the BB signal S1-1 is input to the comparator 12e. With this configuration, the comparator 12e compares an amplified distortion FB signal extracted by the calculator 12d and an original signal of the BB signal S1-1 input via the selector 12b, and detects a distortion component from the results of comparison. A calculator 12f-1 at a rear stage calculates a distortion compensation coefficient for the first system for reducing the distortion component detected by the comparator 12e, and stores the calculation results in the distortion compensation coefficient memory 12c-1 for the first system.

As in the first system side, the distortion compensation is also performed in the second system side. In other words, the directional coupler 13c-2 for the second system branches a part of the output signal from the power amplifier (PA) 13b-2 for the second system, and turns back at the feedback system, thereby performing distortion compensation for the second system. In the digital distortion compensation unit 12, in order to apply the distortion compensation to a signal of the second system, the calculator 12d performs FFT processing to the signal input from the ADC 15, thereby extracting a frequency component. Specifically, in the calculator 12d, a digital filter extracts subcarrier aggregations A2, A4 and distortion signals of distortion compensation monitor points (3510 MHz, 3630 MHz) from the branched BB signal S1-2 input from the ADC 15, and outputs the subcarrier aggregations A2, A4 and the distortion signals to the comparator 12e.

When distortion compensation of the second system is performed, the selector 12b sets a path in such a manner that the signal branched from the BB signal S1-2 is input to the comparator 12e. With this configuration, the comparator 12e compares an amplified distortion FB signal extracted by the calculator 12d and an original signal of the BB signal S1-2 input via the selector 12b, and detects a distortion component from the results of comparison. A calculator 12f-2 at a rear stage calculates a distortion compensation coefficient for the second system for reducing the distortion component detected by the comparator 12e, and stores the calculation results in the distortion compensation coefficient memory 12c-2 for the second system.

By repeatedly performing the above-described series of processing, the transmission signal amplifying apparatus 10 can perform the distortion compensation of the two systems using the distortion compensation coefficients respectively stored in the distortion compensation coefficient memories 12c-1, 12c-2.

Further, ISOs (ISOlators) 13d-1, 13d-2 prevent reverse flows of signals from a Radio Frequency (RF) side. In other words, when the amplified and distortion-compensated BB signal S1-1 is input from the directional coupler 13c-1, the ISO 13d-1 of the transmission side analog unit 13 on the first system side stabilizes impedance of the power amplifier 13b-1 and outputs to a BPF 16-1 at a rear stage. Likewise, when the amplified and distortion-compensated BB signal S1-2 is input from the directional coupler 13c-2, the ISO 13d-2 of the transmission side analog unit 13 on the second system side stabilizes impedance of the power amplifier 13b-2 and outputs to a BPF 16-2 at a rear stage.

Each of the BPFs 16-1, 16-2 adopts a configuration in which a plurality of resonators are connected in series. The BB signals S1-1, S1-2 output from the respective ISOs 13d-1, 13d-2 are band-limited by the respective BPFs 16-1, 16-2, and are then combined by a main signal combiner (COMB_OUT) 17. The combined signal is output from an RF terminal of the transmission signal amplifying apparatus 10 as an RF signal S2.

As described above, since the BB signal S1 input to the transmission signal amplifying apparatus 10 is distributed into two systems, power for amplification by the power amplifiers 13b-1, 13b-2 is ½ of the related case. Therefore, for example, even when a power amplifier of 80 W output device is needed, the transmission signal amplifying apparatus 10 according to the present embodiment can use 40 W output device. As a result, cost reduction and low power consumption are realized.

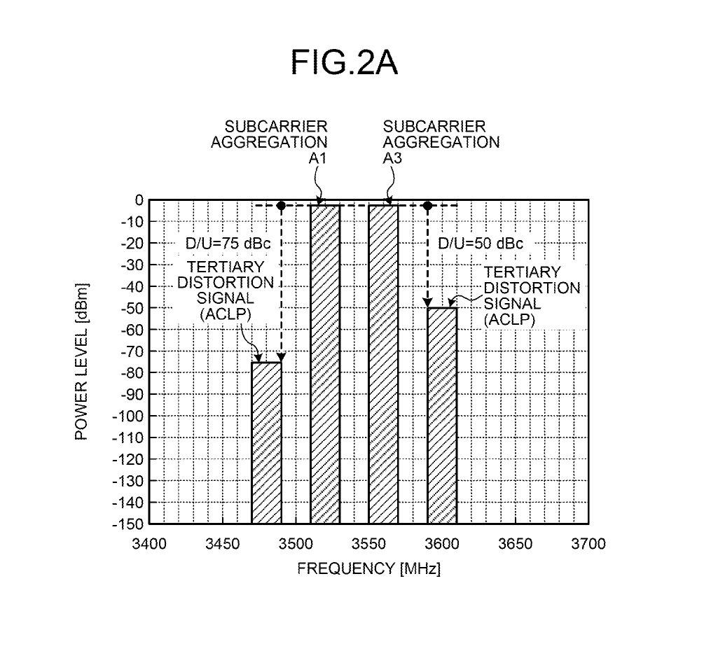

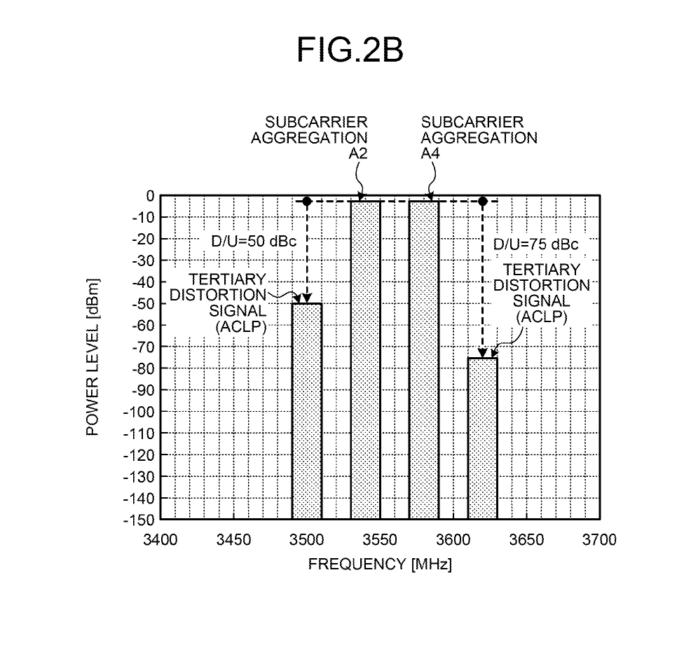

FIG. 2A is a diagram illustrating a spectrum of an output signal from the power amplifier 13b-1 during a distortion compensating operation. In FIG. 2A, a frequency (a unit is MHz) is defined on an x axis, and a power level (a unit is dBm) is defined on a y axis. In FIG. 2A, the spectrum of the BB signal 51-1 corresponds to the subcarrier aggregations A1, A3. The respective subcarrier aggregations A1, A3 are modulated to radio frequencies and then amplified by the power amplifier 13b-1. At this time, tertiary distortion signals appear due to a nonlinear distortion of the power amplifier 13b-1, and adjacent channel leak powers (ACLPs) are generated.

The transmission signal amplifying apparatus 10 according to the present embodiment divides the subcarrier aggregations A1, A3 into two 20 MHz bands (3510 to 3530 MHz, 3550 to 3570 MHz). Accordingly, the tertiary distortion signals appear in frequency bands (3470 to 3490 MHz, 3590 to 3610 MHz) at 20 MHz away from the respective subcarrier aggregations A1, A3, where an interval between the respective subcarrier aggregations A1, A3 is 20 MHz.

Here, as illustrated in FIG. 2A, an amount of generation of the ACLP in a + side (an Upper side) band from a carrier frequency is “−50 dBm”, and is 50 dB lower than a power level of the nearest subcarrier aggregation A3. In contrast to this, an amount of generation of the ACLP in a − side (a Lower side) band from the carrier frequency is “−75 dBm”, and is 75 dBm lower than a power level of the nearest subcarrier aggregation A1. In this way, in the digital distortion compensation unit 12, an equalizer, which controls a frequency deviation, provides a difference between the amounts of generation of the ACLPs.

FIG. 2B is a diagram illustrating a spectrum of an output signal from the power amplifier 13b-2 during a distortion compensating operation. In FIG. 2B, a frequency (a unit is MHz) is defined on an x axis, and a power level (a unit is dBm) is defined on a y axis. In FIG. 2B, the spectrum of the BB signal S1-2 corresponds to the subcarrier aggregations A2, A4. The respective subcarrier aggregations A2, A4 are modulated to radio frequencies and then amplified by the power amplifier 13b-2. At this time, tertiary distortion signals appear due to a nonlinear distortion of the power amplifier 13b-2, and ACLPs are generated.

The transmission signal amplifying apparatus 10 according to the present embodiment divides the subcarrier aggregations A2, A4 into two 20 MHz bands (3530 to 3550 MHz, 3570 to 3590 MHz). Accordingly, the tertiary distortion signals appear in frequency bands (3490 to 3510 MHz, 3610 to 3630 MHz) at 20 MHz away from the respective subcarrier aggregations A2, A4, where an interval between the respective subcarrier aggregations A2, A4 is 20 MHz.

Here, as illustrated in FIG. 2B, an amount of generation of the ACLP in a + side (an Upper side) band from a carrier frequency is “−75 dBm”, and is 75 dB lower than a power level of the nearest subcarrier aggregation A4. In contrast to this, an amount of generation of the ACLP in a − side (a Lower side) band from the carrier frequency is “−50 dBm”, and is 50 dB lower than a power level of the nearest subcarrier aggregation A2. In this way, in the digital distortion compensation unit 12, the equalizer provides a difference between the amounts of generation of the ACLPs.

The frequencies of the subcarrier aggregations A1, A3 on the first system side illustrated in FIG. 2A are 3510 to 3530 MHz, 3550 to 3570 MHz, respectively. In contrast, the frequencies of the subcarrier aggregations A2, A4 on the second system side illustrated in FIG. 2B are 3530 to 3550 MHz, 3570 to 3590 MHz, respectively. Different subcarriers are used for each system. However, when all of the subcarrier aggregations A1 to A4 each having the bandwidth of 20 MHz are combined by the transmission signal amplifying apparatus 10, a 80 MHz signal having the same bandwidth as the BB signal S1, which has been input from a BB terminal, is generated.

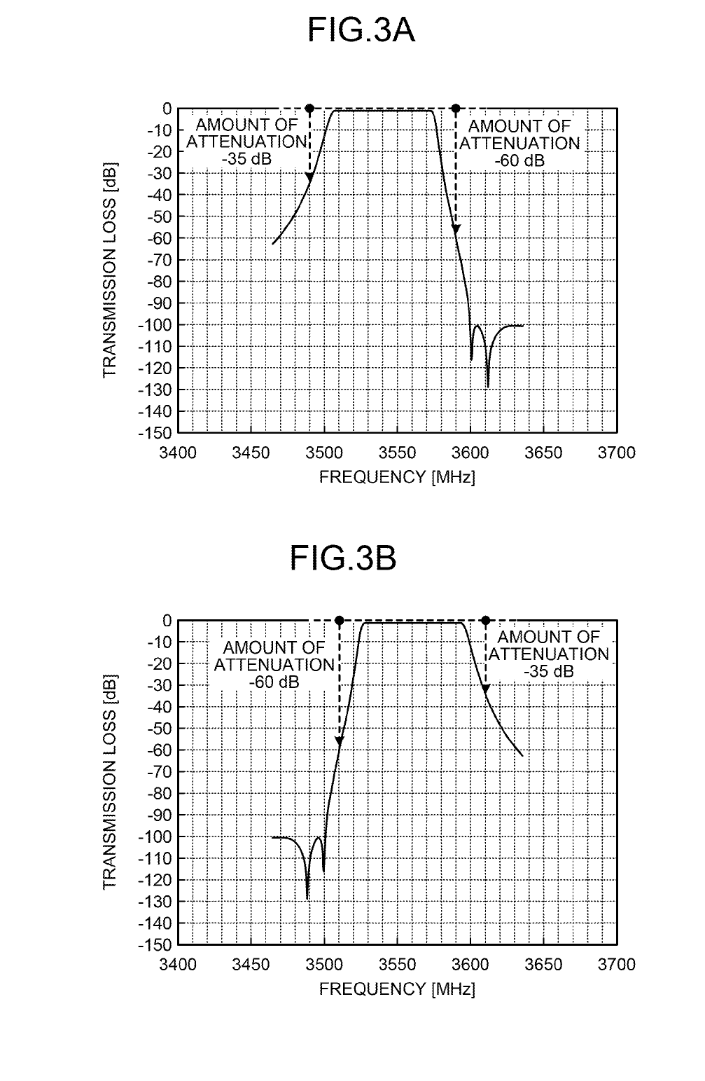

FIG. 3A is a diagram illustrating a pass band characteristic of the BPF 16-1. FIG. 3B is a diagram illustrating a pass band characteristic of the BPF 16-2. In FIGS. 3A and 3B, a frequency (a unit is MHz) is defined on an x axis, and a power level loss (a unit is dB) of the BB signals S1-1, S1-2 is defined on a y axis. As illustrated in FIG. 3A, in order to allow all of the subcarrier aggregations A1, A3 configuring the BB signal S1-1 of the first system to pass, the BPF 16-1 has a pass band characteristic in which an amount of attenuation is substantially “0 dB” in a frequency band of 3510 to 3570 MHz. The BPF 16-1 illustrates the amount of attenuation of “−35 dB” in 3490 MHz and illustrates the amount of attenuation of “−60 dB” in 3590 MHz.

In contrast, as illustrated in FIG. 3B in order to allow all of the subcarrier aggregations A2, A4 configuring the BB signal S1-2 of the second system to pass, the BPF 16-2 has a pass band characteristic in which an amount of attenuation is substantially “0 dB” in a frequency band of 3530 to 3590 MHz. The BPF 16-2 illustrates the amount of attenuation of “−60 dB” in 3510 MHz and illustrates the amount of attenuation of “−dB” in 3610 MHz.

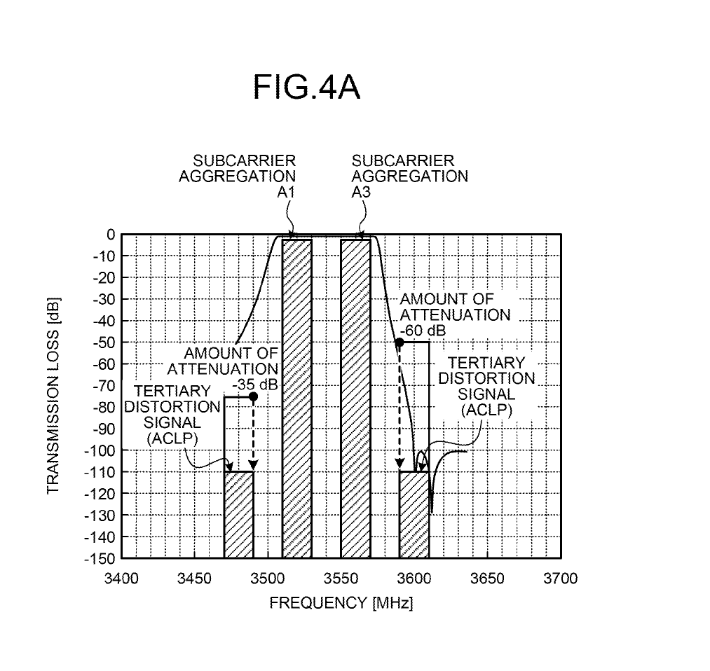

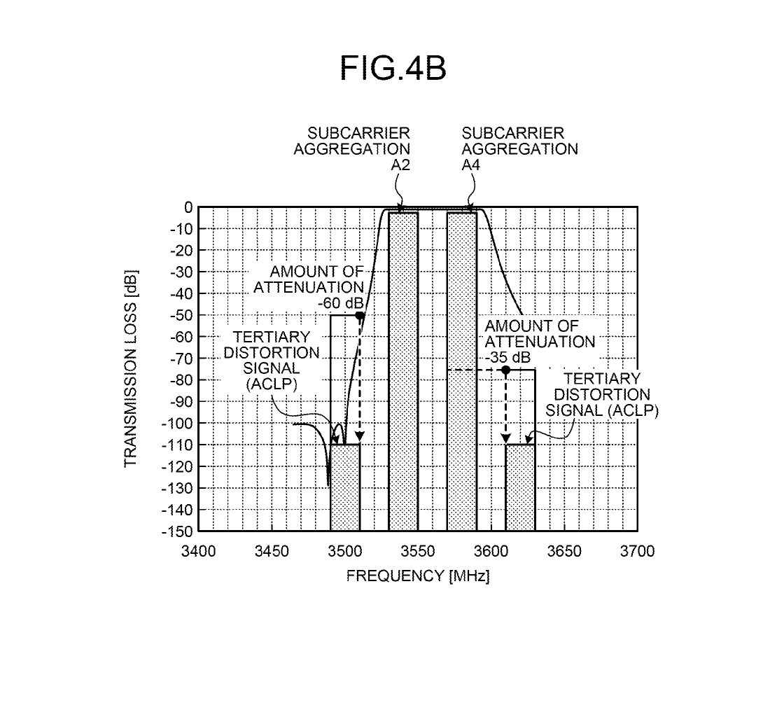

FIG. 4A is a diagram illustrating the pass band characteristic of the BPF 16-1 and an attenuated spectrum of the output signal from the power amplifier 13b-1. As illustrated in FIG. 4A, a pass bandwidth of the BPF 16-1 is 60 MHz of from 3510 to 3570 MHz, and the BPF 16-1 allows a subcarrier signal of 40 MHz (=20 MHz +20 MHz) to pass. There is a gap of 20 MHz between the subcarrier aggregations A1 and A3. The tertiary distortion signal before attenuation on the subcarrier aggregation A3 side (the Upper side) is higher than that on the subcarrier aggregation A1 side (the Lower side) (see FIG. 2A). However, the BPF 16-1 has a notch characteristic on the Upper side. Because of this, the amount of attenuation of the power level is larger on the Upper side than the Lower side. As a result, ACLP signals (distortion signals) output from the power amplifier 13b-1 are reduced to about −110 dB on both the Lower side and the Upper side.

FIG. 4B is a diagram illustrating the pass band characteristic of the BPF 16-2 and an attenuated spectrum of the output signal from the power amplifier 13b-2. As illustrated in FIG. 4B, a pass bandwidth of the BPF 16-2 is 60 MHz of from 3530 to 3590 MHz, and the BPF 16-2 allows a subcarrier signal of 40 MHz (=20 MHz +20 MHz) to pass. There is a gap of 20 MHz between the subcarrier aggregations A2 and A4. Upper and Lower of the pass band characteristic of the BPF 16-2 is inverse to that of the BPF 16-1. In other words, the tertiary distortion signal before attenuation on the subcarrier aggregation A2 side (the Lower side) is higher than that on the subcarrier aggregation A4 side (the Upper side) (see FIG. 2B). However, the BPF 16-2 has a notch characteristic on the Lower side. Because of this, the amount of attenuation is larger on the Lower side than the Upper side. As a result, ACLP signals (distortion signals) output from the power amplifier 13b-2 are reduced to about −110 dB on any of the Lower side and the Upper side.

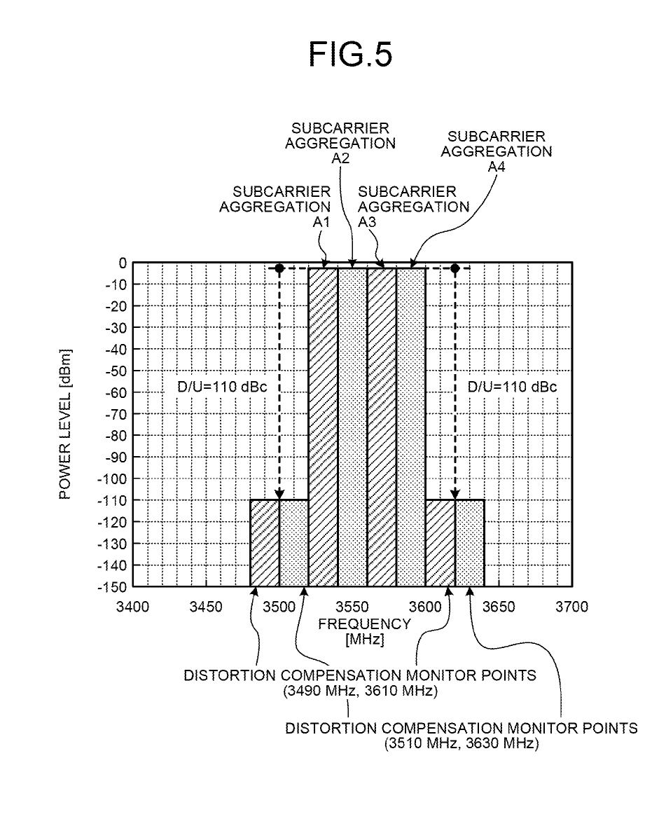

FIG. 5 is a diagram illustrating a combined spectrum of the BB signal S1-1 having passed through the BPF 16-1 and the BB signal S1-2 having passed through the BPF 16-2. When the respective BB signals S1-1, 51-2 are combined by the main signal combiner (COMB_OUT) 17, the BB signals S1-1, S1-2 become a transmission signal with a bandwidth of 80 MHz. At this time, as illustrated in FIG. 5, the distortion signal levels of the ACLP are attenuated to about −110 dBm on both sides.

In the present embodiment, the power amplification by the power amplifiers 13b-1, 13b-2 is performed by dividing into two systems. However, the feedback signals for distortion compensation are combined in both systems and then are input to the ADC 15. Since the digital distortion compensation unit 12 detects a frequency point generated by the tertiary distortion, the signals distorted in the power amplifiers 13b-1, 13b-2 can be distinguished from the original BB signals S1-1, S1-2. Accordingly, by monitoring the distortion level of the frequency at the point, the digital distortion compensation unit 12 can correctly grasp the distortion degree of each of the BB signals S1-1, S1-2.

Then, in the digital distortion compensation unit 12, the calculators 12f-1, 12f-2 calculate the distortion compensation coefficient capable of suppressing the tertiary distortion signal for each subcarrier aggregation pair. The digital distortion compensation unit 12 stores the distortion compensation coefficient of the power amplifier 13b-1, which amplifies the subcarrier aggregations A1, A3, in the distortion compensation coefficient memory 12c-1 for the first system. At the same time, the digital distortion compensation unit 12 stores the distortion compensation coefficient of the power amplifier 13b-2, which amplifies the subcarrier aggregations A2, A4, in the distortion compensation coefficient memory 12c-2 for the second system. Then, in the digital distortion compensation unit 12, the multipliers (MIX) 12a-1, 12a-2 multiply the BB signals S1-1, S1-2 of the respective systems by each stored distortion compensation coefficient. Consequently, the transmission signal amplifying apparatus 10 configures a two system distortion compensation circuit from one system feedback circuit.

As described above, the transmission signal amplifying apparatus 10 has the OFDM subcarrier division unit 11, the transmission side analog unit 13, the digital distortion compensation unit 12, and the main signal combiner (COMB_OUT) 17. The OFDM subcarrier division unit 11 divides the signal (the OFDMA carrier signal) whose frequency bands are continuous, and rearranges and outputs the plurality of subcarrier aggregations A1 to A4 obtained by division in a state in which the frequency bands are not adjacent to each other (e.g., alternate arrangement). While maintaining the state in which the frequency bands of the respective subcarrier aggregations A1 to A4 are not adjacent to each other, the transmission side analog unit 13 amplifies the BB signals S1-1, S1-2 of the plurality of systems having the respective subcarrier aggregations A1 to A4 output from the OFDM subcarrier division unit 11 for the respective BB signals S1-1, S1-2 of the respective systems. The digital distortion compensation unit 12 compensates the distortions of the BB signals S1-1, S1-2 of the plurality of systems amplified by the transmission side analog unit 13. The main signal combiner (COMB_OUT) 17 combines the BB signals S1-1, S1-2 of the plurality of systems, whose distortions have been compensated by the digital distortion compensation unit 12, and outputs as the RF signal S2.

In the transmission signal amplifying apparatus 10, the transmission side analog unit 13 branches a part of the BB signals S1-1, S1-2 of the respective systems and feeds back to the digital distortion compensation unit 12. Using the part of the fed-backed BB signals S1-1, S1-2 of the respective systems, the digital distortion compensation unit 12 may compensate distortions of the respective BB signals S1-1, S1-2 input from the OFDM subcarrier division unit 11 to the respective systems. Further, in the transmission signal amplifying apparatus 10, when dividing the signal whose frequency bands are continuous, the OFDM subcarrier division unit 11 may equally divide the signal in such a manner that the frequency bandwidths of the respective subcarrier aggregations A1 to A4 obtained by the division are the same (e.g., 20 MHz).

The transmission signal amplifying apparatus 10 according to the present embodiment, for example, has the following effects. In other words, the transmission signal amplifying apparatus 10 can efficiently amplify the continuous broadband signal without increasing a circuit scale. Specifically, upon processing the broadband signal for the IMT-Advanced, the transmission signal amplifying apparatus 10 can suppress sensitivity deterioration in the system, to which its own apparatus belongs, interference due to disturbance waves, or the like.

Further, it is not necessary to use a BPF of an 80 MHz band, which is highly difficult to realize. The transmission signal amplifying apparatus 10 can constitute a radio transmission unit of an 80 MHz band using a BPF of a 60 MHz band, which is relatively easy to realize. Thereby, cost reduction of a radio communication device is realized.

Moreover, the transmission signal amplifying apparatus 10 can suppress an increase in power which is consumed to secure linearity of the power amplifiers 13b-1, 13b-2. As a result, amplification of highly efficient transmission power is made possible. More specifically, since the OFDM subcarrier division unit 11 is constituted of a field programmable gate array (FPGA), an increase in power consumption is approximately 1 W. Accordingly, the transmission signal amplifying apparatus 10 can suppress the power consumption accompanied by the broadband amplification more effectively than lowering efficiency of the power amplifiers and securing linearity. Further, the transmission signal amplifying apparatus 10 can lower wattage of the device of the power amplifier to be used. As a result, cost for the device can be suppressed.

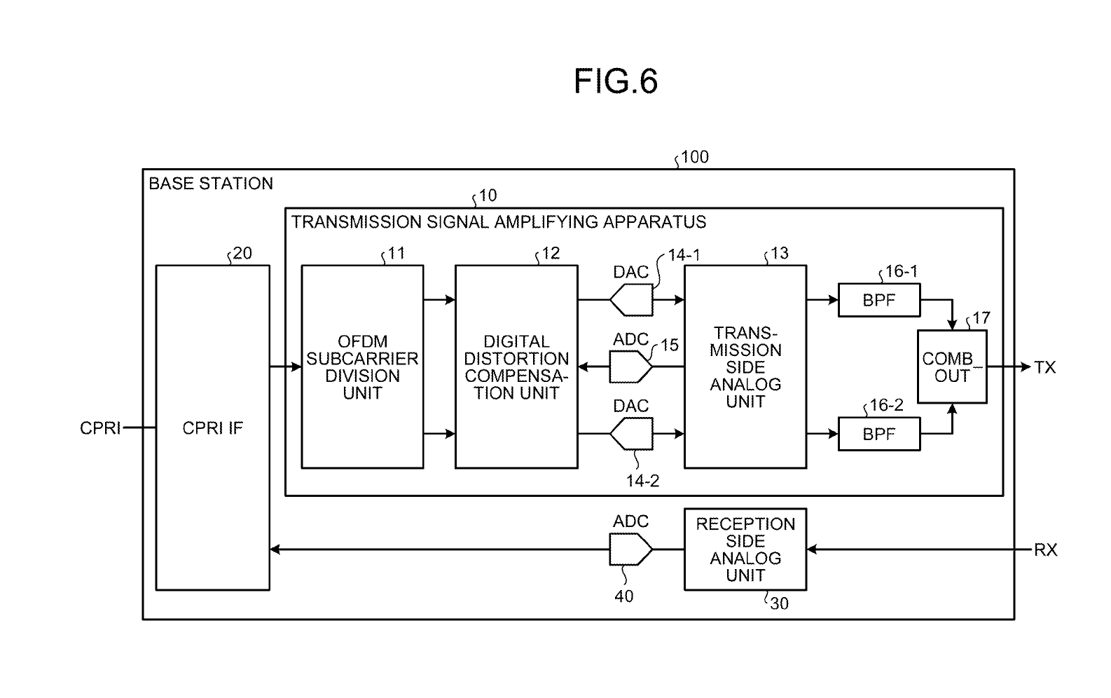

Next, application examples of the transmission signal amplifying apparatus 10 according to the present embodiment will be described. The transmission signal amplifying apparatus 10, for example, can be applied to a base station and a portable terminal. FIG. 6 is a diagram illustrating a structure of a base station 100 having the transmission signal amplifying apparatus 10 according to the present embodiment. In FIG. 6, the same reference numerals are used for components which are common to those in FIG. 1, and detailed descriptions thereof are omitted. As illustrated in FIG. 6, a BB signal is input to and output from a common public radio interface (CPRI) as an optical signal. Upon input of a down BB signal, a CPRI. IF (InterFace) 20 extracts a transmission carrier signal from the BB signal and outputs the transmission carrier signal to an OFDM subcarrier division unit 11.

The transmission signal amplifying apparatus 10 according to the present embodiment is not only limited to the base station but also applied to a portable terminal. Upon application to the portable terminal, the OFDM subcarrier division unit 11 of the transmission signal amplifying apparatus 10 may be configured separately from a Base band (BB) unit or may be incorporated therein as a part of the BB unit.

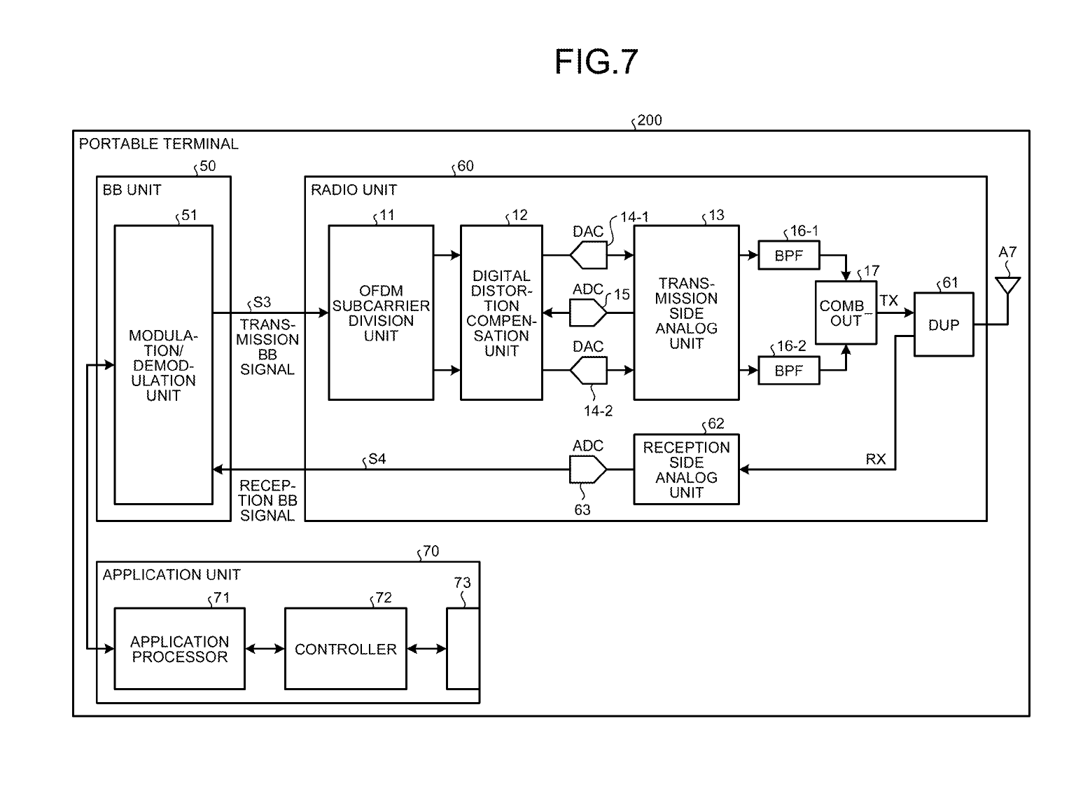

FIG. 7 is a diagram illustrating a structure of a portable terminal 200 in a case where a Base band (BB) unit 50 does not include the OFDM subcarrier division unit 11 according to the present embodiment. In FIG. 7, the same reference numerals are used for components which are common to those in FIG. 1, and detailed descriptions thereof are omitted. As another component, the BB unit 50 has a modulation/demodulation unit 51 which modulates and demodulates a radio signal. A transmission BB signal S3 output from the modulation/demodulation unit 51 arrives at a duplexer (DUP) 61 via a transmission signal amplifying apparatus within a radio unit 60, and is transmitted from an antenna A7. In an application unit 70, an application processor 71 processes an application program capable of executing on the portable terminal 200. Further, the application unit 70 controls various types of interfaces 73, such as a display, a keyboard, a microphone, a speaker, and the like, via a control circuit of a controller 72.

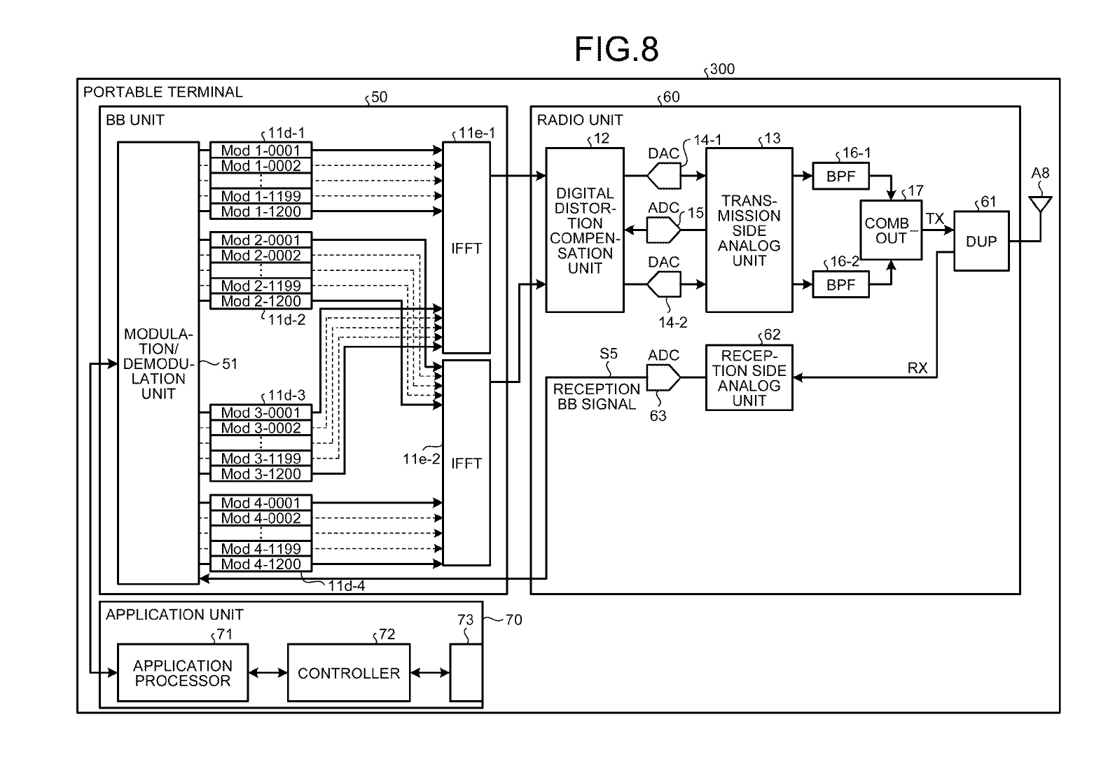

Next, FIG. 8 is a diagram illustrating a structure of a portable terminal 300 in a case where a Base band (BB) unit 50 includes the OFDM subcarrier division unit 11 according to the present embodiment. In FIG. 8, the same reference numerals are used for components which are common to those in FIG. 1, and detailed descriptions thereof are omitted. In this embodiment, an FFT circuit is shared by the BB unit 50. Accordingly, as illustrated in FIG. 8, the portable terminal 300 can omit an FFT circuit for subcarrier processing in comparison with FIG. 7. In other words, the modulation/demodulation unit 51 illustrated in FIG. 7 combines all subcarrier aggregations A1 to A4, and then performs transmission from the BB unit 50 to the radio unit 60. In contrast, the BB unit 50 in FIG. 8 performs OFDM modulation to a BB signal S1, and then individually combines each pair of subcarrier aggregations (a pair of A1 and A3 and a pair of A2 and A4) without combining all of the subcarrier aggregations A1 to A4. After that, transmission is performed from the BB unit 50 to a radio unit 60. By employing this embodiment, unlike the embodiment in FIG. 7, the portable terminal 300 can eliminate an OFDM subcarrier division unit from the radio unit 60. Accordingly, miniaturization of a circuit and low power consumption are made possible.

In the above-described embodiments, the continuous signal with a frequency bandwidth of 80 MHz is illustrated as the BB signal (OFDMA carrier signal) input to the transmission signal amplifying apparatus 10. However, the BB signal can be a signal with other frequency bandwidth (e.g., 100 MHz) as long as the BB signal has a continuous frequency band. Further, the continuous frequency band is not limited to 3520 to 3600 MHz illustrated in FIG. 5, and other frequency band may be used.

The frequency band is not necessarily divided into four subcarrier aggregations. For example, in a case where the continuous frequency band is 120 MHz, the transmission signal amplifying apparatus 10 can divide the signal with the above-described frequency band into six subcarrier aggregations A1 to A6 each with 20 MHz. In this embodiment, for example, the subcarrier aggregations A1, A3, A5 whose frequency bands are not adjacent to each other constitute a BB signal S1-1 of the first system, and the other subcarrier aggregations A2, A4, A6 constitute a BB signal S1-2 of the second system.

Further, also regarding the method of dividing the frequency band, it is desirable that the transmission signal amplifying apparatus 10 divide the continuous frequency band equally from the viewpoint of suppressing the ACLPs and improving the signal amplification efficiency. However, the respective subcarrier aggregations do not necessarily have the same frequency bandwidth. For example, in a case where the continuous frequency band is 100 MHz, the transmission signal amplifying apparatus 10 may divide the signal of the frequency band in such a manner that the frequency bandwidths of the respective subcarrier aggregations A1 to A4 are 30 MHz, 20 MHz, 30 MHz, and 20 MHz.

Additionally, the respective subcarrier aggregations A1 to A4 obtained by the division constitute the BB signals S1-1, S1-2 of the two systems. However, the number of divided systems is not necessarily two, and may be three or more.

According to the embodiments, the continuous broadband signal can be efficiently amplified.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A signal amplifying apparatus comprising:
a division unit that divides a signal whose frequency bands are continuous, and outputs a plurality of subcarrier aggregations obtained by the division, in a state in which the frequency bands are not adjacent to each other;
an amplification unit that amplifies signals of a plurality of systems including the respective subcarrier aggregations output from the division unit for the respective signals of the systems, while maintaining the state;
a distortion compensation unit that compensates distortions of the signals of the plurality of systems amplified by the amplification unit; and
a combining unit that combines the signals of the plurality of systems whose distortions have been compensated by the distortion compensation unit, and outputs as a radio signal.

2. The signal amplifying apparatus according to claim 1,
wherein the amplification unit branches a part of the signal of each system, and feeds back to the distortion compensation unit, and
the distortion compensation unit compensates the distortion of each signal input for each system from the division unit, using a part of the fed-back signal of each system.

3. The signal amplifying apparatus according to claim 1, wherein upon dividing the signal whose frequency bands are continuous, the division unit divides the signal equally in such a manner that frequency bandwidths of the respective subcarrier aggregations obtained by the division are the same.

4. A transmitter comprising:
a signal amplifying apparatus including:
a division unit that divides a signal whose frequency bands are continuous, and outputs a plurality of subcarrier aggregations obtained by the division, in a state in which the frequency bands are not adjacent to each other;
an amplification unit that amplifies signals of a plurality of systems including the respective subcarrier aggregations output from the division unit for the respective signals of the systems, while maintaining the state;
a distortion compensation unit that compensates distortions of the signals of the plurality of systems amplified by the amplification unit; and
a combining unit that combines the signals of the plurality of systems whose distortions have been compensated by the distortion compensation unit, and outputs as a radio signal; and
a transmission unit that transmits the radio signal output from the combining unit of the signal amplifying apparatus.

5. A signal amplifying method comprising:
in a signal amplifying apparatus,
dividing a signal whose frequency bands are continuous, and outputting a plurality of subcarrier aggregations obtained by the division, in a state in which the frequency bands are not adjacent to each other;
amplifying signals of a plurality of systems including the respective output subcarrier aggregations for the respective signals of the systems, while maintaining the state;
compensating distortions of the amplified signals of the plurality of systems; and
combining the signals of the plurality of systems whose distortions have been compensated, and outputting as a radio signal.
